(19) United States
(12) Patent Application Publication
(10) Pub. No.: US 2005/0194562 A1
(43) Pub. Date: Sep. 8, 2005

(54) Polishing compositions for controlling metal interconnect removal rate in semiconductor wafers

(76) Inventors: Raymond Lee Lavoie JR., Chesapeake City, MD (US); John Quanci, Haddonfield, NJ (US); Qianqiu Ye, Willmington, DE (US)

Correspondence Address: Rohm and Haas Electronic,;Materials CMP Holdings, Inc., Suite 1300, 1105 North Market Street, Wilmington, DE, 19899, US

(21) Appl. No.: 10/785,666

(22) Filed: Feb. 23, 2004

(51) Int. Cl. B24B 1/00; B44C 1/22

(52) U.S. Cl. 252/79.1; 216/88; 216/89

(57) ABSTRACT

A polishing composition suitable for polishing semiconductor substrates comprises 0.001 to 2 wt % of a thermoplastic polymer; and 0.001 to 1 wt % of polyvinylpyrrolidone; wherein varying the weight ratio of thermoplastic polymer to the polyvinylpyrrolidone controls the removal rate of the non-ferrous interconnect.

### BACKGROUND OF THE INVENTION

This disclosure relates to the polishing of semiconductor wafers and more particularly, to polishing compositions and methods for controlling metal interconnect removal rate in semiconductor wafers.

The semiconductor industry uses interconnect metals in forming integrated circuits on semiconductor wafers. These interconnect metals are preferably non-ferrous metals. Suitable examples of such non-ferrous interconnects are aluminum, copper, gold, nickel, and platinum group metals, silver, tungsten and alloys comprising at least one of the foregoing metals. These interconnect metals have a low electrical resistivity. Copper metal interconnects provide excellent conductivity at a low cost. Because copper is highly soluble in many dielectric materials, such as silicon dioxide or doped versions of silicon dioxide, integrated circuit fabricators typically apply a diffusion barrier layer to prevent the copper diffusion into the dielectric layer. For example, barrier layers for protecting dielectrics include, tantalum, tantalum nitride, tantalum-silicon nitrides, titanium, titanium nitrides, titanium-silicon nitrides, titanium-titanium nitrides, titanium-tungsten, tungsten, tungsten nitrides and tungsten-silicon nitrides.

In the manufacturing of semi-conductor wafers, polishing compositions are used to polish semiconductor substrates after the deposition of the metal interconnect layers. Typically, the polishing process uses a “first-step” slurry specifically designed to rapidly remove the metal interconnect. The polishing process then includes a “second-step” slurry to remove the barrier layer. The second-step slurries selectively remove the barrier layer without adversely impacting the physical structure or electrical properties of the interconnect structure.

U.S. Pat. No. 6,443,812 to Costas et al., discloses a polishing composition comprising an organic polymer having a backbone comprising at least 16 carbon atoms, wherein the polymer has a plurality of moieties with an affinity to surface groups on the semiconductor wafer surface. The polishing composition does not, however, prevent dishing of the low-k dielectric layer and does not recognize controlling the removal rate of the low k dielectric materials. The composition further does not recognize tuning of the slurry.

There remains an unsatisfied demand for aqueous polishing compositions that can be used to control the removal rate of the non-ferrous interconnect metals as well as control the removal rate of low-k and ultra-low-k dielectric materials.

### SUMMARY

Disclosed herein is a polishing composition suitable for polishing semiconductor substrates comprising 0.001 to 2 wt % of a thermoplastic polymer; and 0.001 to 1 wt % of polyvinylpyrrolidone; wherein increasing the weight ratio of thermoplastic polymer to the polyvinylpyrrolidone controls the removal rate of the non-ferrous interconnect.

Disclosed herein too is a polishing composition suitable for polishing semiconductor substrates comprising 0.001 to 2 wt % of polyvinyl alcohol having a weight average molecular weight of 13,000 to 23,000 g/mole; 0.001 to 1 wt % of polyvinylpyrrolidone having a weight average molecular weight of 3,000 to 10,000 g/mole; up to 15 wt % complexing agent; up to 10 wt % of a corrosion inhibitor; up to 10 wt % of an oxidizing agent; and 0.1 to 40 wt % of a silica abrasive; wherein the polishing composition has a pH of at least 7, and further wherein increasing the weight ratio of thermoplastic polymer to the polyvinylpyrrolidone controls the removal rate of the non-ferrous interconnect.

Disclosed herein too is a method of polishing semiconductor substrates comprising the steps of applying a polishing composition comprising 0.001 to 2 wt % of a thermoplastic polymer; and 0.001 to 1 wt % of polyvinylpyrrolidone to a semiconductor substrate; and polishing the semiconductor wafer at a pad pressure less than or equal to 21.7 kiloPascals, wherein increasing the weight ratio of thermoplastic polymer to the polyvinylpyrrolidone controls the removal rate of the non-ferrous interconnect.

### DETAILED DESCRIPTION OF PREFERRED EMBODIMENTS

Thermoplastic polymers that may be used in the polishing composition are oligomers, polymers, ionomers, dendrimers, copolymers such as block copolymers, graft copolymers, star block copolymers, random copolymers, or the like, or combinations comprising at least one of the foregoing polymers. Suitable examples of thermoplastic polymers that can be used in the polishing composition are polyacetals, polyacrylics, polycarbonates polystyrenes, polyesters, polyamides, polyamideimides, polyarylates, polyarylsulfones, polyethersulfones, polyphenylene sulfides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or the like, or combinations comprising at least one of the foregoing thermoplastic polymers. A preferred thermoplastic polymer is polyvinyl alcohol.

Blends of thermoplastic polymers may also be used. Examples of blends of thermoplastic polymers include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, nylon/elastomers, polyester/elastomers, polyethylene terephthalate/polybutylene terephthalate, acetal/elastomer, styrene-maleicanhydride/acrylonitrile-butadiene-styrene, polyether etherketone/polyethersulfone, polyethylene/nylon, polyethylene/polyacetal, and the like, and mixtures comprising at least one of the foregoing blends of thermoplastic polymers.

The thermoplastic polymers preferably have weight average molecular weights of 1,000 to 1,000,000 grams/mole as determined by gel permeation chromatography (GPC). In one embodiment, the thermoplastic polymers have weight average molecular weights of 3,000 to 500,000 grams/mole. In another embodiment, the thermoplastic polymers have weight average molecular weights of 5,000 to 100,000 grams/mole. In yet another embodiment, the thermoplastic polymers have weight average molecular weights of 10,000 to 30,000 grams/mole. It is to be noted that for purposes of this specification, all ranges are inclusive and combinable.

The preferred thermoplastic polymer is polyvinylalcohol having a weight average molecular weight of 13,000 to 23,000 grams/mole. In one embodiment, the polyvinylalcohol has a degree of hydrolyzation of greater than or equal to 80 mole percent. In another embodiment, the polyvinylalcohol has a degree of hydrolyzation of greater than or equal to 50 mole percent. In yet another embodiment, the polyvinylalcohol has a degree of hydrolyzation of greater than or equal to 20 mole percent. The mole percent is based on the total number of moles of polyvinylalcohol.

The thermoplastic polymers are present in amounts of 0.001 to 2 wt %. In one embodiment, the thermoplastic polymers are present in amounts of 0.01 to 1.7 wt %. In another embodiment, the thermoplastic polymers are present in amounts of 0.1 to 1.5 wt %. As used herein, and throughout this specification, the respective weight percents are based on the total weight of the polishing composition.

The weight average molecular weight of polyvinylpyrrolidone is 100 to 1,000,000 grams/mole as determined by GPC. In one embodiment, the polyvinylpyrrolidone has a weight average molecular weight of 500 to 500,000 grams/mole. In another embodiment, the polyvinylpyrrolidone has a weight average molecular weight of 1,000 to 250,000 grams/mole. In yet another embodiment, the polyvinylpyrrolidone has a weight average molecular weight of 5,000 to 100,000 grams/mole. An exemplary weight average molecular weight for the polyvinylpyrrolidone polymer is 8,000 to 12,000 grams/mole, with a nominal weight average molecular weight of 10,000 grams/mole being most preferred.

The addition of the thermoplastic polymers as well as the polyvinylpyrrolidone to the polishing composition provides the polished surface of the semiconductor substrate with a reduced surface roughness and fewer scratches than when the polishing composition is used without thermoplastic polymers. For purposes of this specification, removal rate refers to a change of thickness per unit time, such as, Angstroms per minute.

The polyvinylpyrrolidone is generally present in the polishing composition in an amount of 0.001 to 1 wt %. In one embodiment, the polyvinylpyrrolidone is present in an amount of 0.01 to 0.85 wt %. In another embodiment, the polyvinylpyrrolidone is present in an amount of 0.1 to 0.75 wt %.

It is desirable to utilize the polyvinylpyrrolidone and thermoplastic polymer in a weight ratio of 1:10 to 100:1 respectively. In one embodiment, it is desirable to utilize the polyvinylpyrrolidone and thermoplastic polymer in a weight ratio of 1:5 to 50:1 respectively. In another embodiment, it is desirable to utilize the polyvinylpyrrolidone and thermoplastic polymer in a weight ratio of 1:5 to 60:1 respectively. In yet another embodiment, it is desirable to utilize the polyvinylpyrrolidone and thermoplastic polymer in a weight ratio of 1:3 to 10:1 respectively.

The polishing composition advantageously includes an abrasive for “mechanical” removal of cap layers and barrier layers. The abrasive is preferably a colloidal abrasive. Suitable examples of abrasives include the following: inorganic oxide, inorganic oxides having hydroxide coatings, metal boride, metal carbide, metal nitride, or a combination comprising at least one of the foregoing abrasives. Suitable inorganic oxides include, for example, silica (SiO₂), silica particles coated with aluminum hydrous oxide, ellipsoidal particles of different anisometry coated with silica, silica particles coated with ceria hydroxide particles, alumina (Al₂O₃), titania (TiO₂), zirconia (ZrO₂), ceria (CeO₂), manganese oxide (MnO₂), and combinations comprising at least one of the foregoing inorganic oxides.

Alumina particles have been found to form aluminum silicate. Aluminum silicate is an amphoteric species, which associates with the silica surface. Thus, the aluminum silicate, once formed, tends to stay on the silica surface and protect it. Alumina is available in many forms such as alpha-alumina, gamma-alumina, delta-alumina, and amorphous (non-crystalline) alumina. A suitable example of alumina is boehmite (AlO(OH)). Modified forms of these inorganic oxides such as polymer-coated inorganic oxide particles may also be utilized if desired. Suitable metal carbides, boride and nitrides include, for example, silicon carbide, silicon nitride, silicon carbonitride (SiCN), boron carbide, tungsten carbide, zirconium carbide, aluminum boride, tantalum carbide, titanium carbide, and mixtures comprising at least one of the foregoing metal carbides, boride and nitrides. Diamond may also be utilized as an abrasive if desired. Alternative abrasives also include polymeric particles and coated polymeric particles. The preferred abrasive is colloidal silica.

The abrasive has an average particle size of less than or equal to 200 nanometers (nm) for preventing excessive metal dishing and dielectric erosion. For purposes of this specification, particle size refers to the average particle size of the abrasive. It is desirable to use an abrasive having an average particle size of less than or equal to 100 nm, preferably less than or equal to 75 nm and preferably less than or equal to 50 nm. The least metal dishing and dielectric erosion advantageously occurs with silica having an average particle size of 10 to 50 nm. Most preferably, the silica has an average particle size of 20 to 40 nm. In addition, the preferred abrasive may include additives, such as dispersants to improve the stability of the abrasive. One such abrasive is colloidal silica from Clariant S.A., of Puteaux, France. If the polishing composition does not contain abrasives, then pad selection and conditioning becomes more important to the polishing process. For example, for some silica-free compositions, a fixed abrasive pad improves polishing performance.

A low abrasive concentration can improve the polishing performance of a polishing process by reducing undesired abrasive induced defects, such as scratching. By employing an abrasive having a relatively small particle size and formulating the polishing composition at a low abrasive concentration, better control can be maintained over the removal rate for the non-ferrous metal interconnect and the low-k dielectric.

It is desired to use the abrasive in an amount of 0.05 wt % to 40 wt %. In one embodiment, it is desired to use the abrasive in an amount of 0.1 to 10 wt %. In another embodiment, it is desired to use the abrasive in an amount of 0.5 to 5 wt %.

It is desirable to include an oxidizing agent in the polishing composition for facilitating the removal of non-ferrous metal interconnects such as aluminum, aluminum alloys, copper, copper alloys, gold, gold alloys, nickel, nickel alloys, platinum group metals, platinum group alloys, silver, silver alloys, tungsten and tungsten alloys or combinations comprising at least one of the foregoing metals. Suitable oxidizing agents include, for example, hydrogen peroxide, monopersulfates, iodates, magnesium perphthalate, peracetic acid and other peracids, persulfates, bromates, periodates, nitrates, iron salts, cerium salts, manganese (Mn) (III), Mn (IV) and Mn (VI) salts, silver salts, copper salts, chromium salts, cobalt salts, halogens, hypochlorites, and combinations comprising at least one of the foregoing oxidizers. The preferred oxidizer is hydrogen peroxide. It is to be noted that the oxidizer is occasionally added to the polishing composition just prior to use and in such instances the oxidizer is contained in a separate package. In one embodiment, the oxidizing agent is present in an amount of 0.1 to 10 wt %. In another embodiment, the oxidizing agent is present in an amount of 0.2 to 5 wt %.

The polishing composition also advantageously comprises a corrosion inhibitor, also commonly termed a film-forming agent. The corrosion inhibitor may be any compound or mixtures of compounds that are capable of chemically binding to the surface of a substrate feature to form a chemical complex wherein the chemical complex is not a metal oxide or hydroxide. The chemical complex acts as a passivating layer and inhibits the dissolution of the surface metal layer of the metal interconnect.

The preferred corrosion inhibitor is benzotriazole (BTA). In one embodiment, the polishing composition may contain a relatively large quantity of BTA inhibitor for reducing the interconnect removal rate. The inhibitor is present in an amount of up to 10 wt %. In one embodiment, the inhibitor is present in an amount of 0.025 to 4 wt %. In another embodiment, the inhibitor is present in an amount of 0.25 to 1 wt %. When BTA is used, it can be used in a concentration of up to the limit of solubility in the polishing composition, which may be up to 2 wt % or the saturation limit in the polishing composition. The preferred concentration of BTA is an amount of 0.0025 to 2 wt %. Optionally, a supplementary corrosion inhibitor may be added to the polishing composition. Supplementary corrosion inhibitors are surfactants such as, for example, anionic surfactants, nonionic surfactants, amphoteric surfactants and polymers, or organic compounds such as azoles. In addition, azoles may be used to toggle or control the copper removal rate. For example, the supplementary inhibitor may include an imidazole, tolytriazole or a mixture thereof in combination with BTA. The addition of tolytriazole reduces the copper removal rate, while the addition of imidazole increases the copper removal rate. A combination of tolytriazole with imidazole may be used to toggle or control the copper removal rate.

The polishing composition has a basic pH to toggle or control the metal interconnect removal rate and the low-k or ultra low-k dielectric rate as desired. It is generally desirable for the polishing composition to have a pH of at least 7. In one embodiment, the pH of the polishing composition may be greater than or equal to 8. The polishing composition also includes an inorganic or an organic pH adjusting agent to vary the pH of the polishing composition. Suitable acidic pH adjusting agents include, for example, nitric acid, sulfuric acid, hydrochloric acid, phosphoric acid, and the like, and combinations comprising at least one of the foregoing acidic pH adjusting agents. The preferred pH adjusting agent is nitric acid. Basic pH adjusting agents may also be used in the polishing composition. Suitable examples of pH adjusting agents are sodium hydroxide, ammonium hydroxide, potassium hydroxide, and the like, as well as combinations comprising at least one of the foregoing basic pH adjusting agents. The balance of the aqueous composition is water and preferably deionized water.

Optionally, the polishing composition may contain a chelating or complexing agent to adjust the copper removal rate relative to the barrier metal removal rate. The chelating or complexing agent improves the copper removal rate by forming a chelated metal complex with copper. Exemplary complexing agents for optional use in the polishing fluid include acetic acid, citric acid, ethyl acetoacetate, glycolic acid, lactic acid, malic acid, oxalic acid, salicylic acid, sodium diethyl dithiocarbamate, succinic acid, tartaric acid, thioglycolic acid, glycine, alanine, aspartic acid, ethylene diamine, trimethylene diamine, malonic acid, gluteric acid, 3-hydroxybutyric acid, propionic acid, phthalic acid, isophthalic acid, 3-hydroxy salicylic acid, 3,5-dihydroxy salicylic acid, gallic acid, gluconic acid, pyrocatechol, pyrogallol, gallic acid, tannic acid and salts thereof. Preferably, the complexing agent used in the polishing fluid is citric acid. Most preferably, the polishing fluid comprises up to 15 weight percent of the complexing and/or chelating agent.

Optionally, the polishing composition can also include buffering agents such as various organic and inorganic acids, and amino acids or their salts with a pKa that is greater than or equal to 5. Optionally, the polishing composition can further include defoaming agents, such as non-ionic surfactants including esters, ethylene oxides, alcohols, ethoxylate, silicon compounds, fluorine compounds, ethers, glycosides and their derivatives, and mixtures comprising at least one of the foregoing surfactants. The defoaming agent may also be an amphoteric surfactant. The polishing composition can also optionally include pH buffers, biocides and defoaming agents.

It is generally preferred to use the polishing composition on semiconductor substrates having non-ferrous interconnects. Suitable metals used for the interconnect include, for example, aluminum, aluminum alloys, copper, copper alloys, gold, gold alloys, nickel, nickel alloys, platinum group metals, platinum group alloys, silver, silver alloys, tungsten and tungsten alloys or combinations comprising at least one of the foregoing metals. The preferred interconnect metal is copper.

The polishing composition enables the polishing apparatus to operate with a low pressure of less than 21.7 kPa (3 psi). The preferred pad pressure is 3.5 to 21.7 kPa (0.5 to 3 (psi)). Within this range, a pressure of less than or equal to 13.8 kPa (2 psi), more preferably less than or equal to 10.3 kPa (1.5 psi), and most preferably less than or equal to 6.9 kPa (1 psi) may be advantageously used. Most preferably, the polishing occurs with the polishing pad and conditions of the Example shown below. The low polishing pad pressure improves polishing performance by reducing scratching and other undesired polishing defects and reduces damage to fragile materials. For example, low dielectric constant materials fracture and delaminate when exposed to high stresses. The polishing compositions comprising the thermoplastic polymers and the polyvinylpyrrolidone advantageously permit high barrier layer and cap layer removal rates while facilitating control over the removal rates for the non-ferrous metal interconnect as well as the low-k and ultra-low-k dielectric layers derived from organic materials such as carbon doped oxides. In an exemplary embodiment, the polishing composition can be adjusted or tuned so as to advantageously achieve a high barrier removal rate without substantial damage to the low-k or ultra-low-k dielectric layer. The polishing compositions can be advantageously used to reduce erosion in patterned wafers having a variety of line widths.

The polishing composition has a tantalum nitride removal rate of two times to four times greater than that of the copper removal rate at a pad pressure of 3.5 to 21.7 kPa as measured with a polishing pad pressure measured normal to an integrated circuit wafer and using a porous polyurethane polishing pad. The polishing composition has a tantalum nitride removal rate of greater than or equal to two times that of the low-k dielectric removal rate at a pad pressure of 3.5 to 21.7 kPa as measured with a polishing pad pressure measured normal to an integrated circuit wafer and using a porous polyurethane polishing pad. A particular polishing pad useful for determining selectivity is the IC1010™ porous-filled polyurethane polishing pad using the conditions of the Example. The polishing compositions can be created before or during the polishing operation. If created during the polishing operation, the polishing fluid can be introduced into a polishing interface and then some or all of the particles can be introduced into the polishing interface by means of particle release from a polishing pad.

Some embodiments of the invention will now be described in detail in the following Examples.

### EXAMPLE

The nomenclature for the materials used in the polishing compositions for the following examples are shown in Table 1 below. The Klebosol 1501-50 is a silica available from Clariant, having 30 wt % silica particles of average size equal to 50 nm and a pH of 10.5 to 11. The sample is diluted down to 12 wt % silica particles by using deionized water.

TABLE 1

| Nomenclature | Name |
|---|---|
| BTA | Benzotriazole |
| CA | Citric acid |
| Klebosol 1501-50 | colloidal silica |
| H₂O₂ | hydrogen peroxide |
| Polyvinylpyrrolidone | commercially available from ISP |
| | technology having a molecular weight of |
| | 10,000 g/mole. |
| Polyvinylalcohol | commercially available from Aldrich |
| | having a molecular weight of 13,000 to |
| | 23,000 g/mole and a degree of |
| | hydrolyzation of 87 to 89 mole %. |

This example was undertaken to demonstrate that a polishing composition comprising polyvinylpyrrolidone and polyvinyl alcohol can be effectively used to vary the copper removal rate while reducing the removal rate for the low-k and ultra low-k dielectrics such as a carbon doped oxide. Polishing experiments were performed using Mirra model wafer polishing machine supplied by Applied Materials. The polishing pad was an IC1010™ supplied by Rohm and Haas Electronic Material CMP Technologies. The pad was conditioned prior to each run. The polishing process was performed at a pressure of 13.78 kPa (2 psi), a table speed of 120 revolutions per minute (rpm) and a carrier speed of 114 rpm. The polishing composition supply rate (slurry flow rate) was 200 milliliters/minute (ml/min). All tests employed 200 mm blanket wafers.

In this example, several polishing compositions were prepared with different polyvinylpyrrolidone and polyvinylalcohol concentrations as shown in Table 2. Optional additives that were added to the formulations shown in the Table 2 were ammonium chloride in an amount of 0.01 wt % and a biocide e.g., KORDEK™ (commercially available from Rohm and Haas Company) in an amount of 0.005 wt % (active ingredient). Comparative polishing compositions having only polyvinylpyrrolidone were also tested. The comparative polishing compositions shown in the Table 2 are samples 1, 5 and 6. Table 2 shows removal rates (RR) for tantalum nitride (TaN), copper (Cu), TEOS, carbon-oxide doped oxide (CDO) and SiCN in Angstroms/minute. THE CDO was CORAL low k dielectric from Novellus Systems, Inc.

TABLE 2

| | | | | | PVP/ | | | | | | |
|---|---|---|---|---|---|---|---|---|---|---|---|
| | | | | | PVA | | | | | | |
| Sample | CA | BTA | PVP | PVA | Wt. | TEOS | | TaN | CDO | SiCN | Cu/TaN |
| # | (wt %) | (wt %) | (wt %) | (wt %) | ratio | RR | Cu RR | RR | RR | RR | RR ratio |
| 1* | 0.30 | 0.05 | 0.60 | | — | 421 | 235 | ND | 41 | 187 | — |
| 2 | 0.30 | 0.05 | 0.60 | 0.10 | 6 | 373 | 159 | 606 | 140 | 283 | 0.26 |
| 3 | 0.30 | 0.05 | 0.60 | 1.00 | 0.6 | 263 | 47 | 645 | 121 | 227 | 0.07 |
| 4 | 0.30 | 0.05 | 0.60 | 0.50 | 1.2 | 299 | 83 | 607 | 150 | 254 | 0.13 |
| 5* | 0.30 | 0.05 | 0.60 | | — | 441 | 232 | 705 | 69 | 239 | 0.32 |
| 6* | 0.30 | 0.05 | 0.20 | | — | 648 | 123 | 903 | 155 | ND | 0.13 |
| 7 | 0.30 | 0.05 | 0.20 | 0.10 | 2 | 623 | 80 | ND | 260 | 438 | — |
| 8 | 0.30 | 0.05 | 0.3 | 0.005 | 60 | 444 | 357 | 637 | 365 | 512 | 0.56 |
| 9 | 0.30 | 0.05 | 0.3 | 0.05 | 6 | 581 | 173 | 696 | 273 | 478 | 0.24 |

RR = removal rate in Angstroms/minute
*Comparative Example
ND = not determined

From the Table 2 it may be seen that as the ratio of polyvinylalcohol to polyvinylpyrrolidone is increased, the removal rate of copper is reduced, while the removal rate of a low-k dielectric or carbon doped oxide such as the CDO layer is still maintained at a very low rate. It may also be seen that preferably the copper removal rates may be varied while maintaining control of the removal rates for the low-k dielectric. From the Table 2, it may also be seen that the polishing compositions containing both the polyvinylalcohol and polyvinylpyrrolidone can also be used to maintain an accelerated removal rate of the barrier materials such as TEOS and tantalum nitride (TaN).

1. A polishing composition suitable for polishing semiconductor substrates having a non-ferrous interconnect comprising:
0.1 to 1.5 wt % of a thermoplastic polymer; and
0.01 to 0.85 wt % of polyvinylpyrrolidone; wherein varying the weight ratio of the thermoplastic polymer to the polyvinylpyrrolidone controls the removal rate of the non-ferrous interconnect.

2. The composition of claim 1, wherein the thermoplastic polymers are polyacetals, polyacrylics, polycarbonates polystyrenes, polyesters, polyamides, polyamideimides, polyarylates, polyarylsulfones, polyethersulfones, polyphenylene sulfides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or a combination comprising at least one of the foregoing thermoplastic polymers.

3. The composition of claim 1, further comprising 0.1 to 40 wt % of silica particles.

4. The composition of claim 1, wherein the thermoplastic polymer is a polyvinylalcohol having a weight average molecular weight of 1,000 to 1,000,000 grams per mole and a degree of hydrolyzation of at least 20 mole percent, wherein the mole percent is based upon the total number of moles of the polyvinylalcohol.

5. The composition of claim 1, wherein the polyvinylpyrrolidone has a weight average molecular weight of 100 to 1,000,000 grams per mole.

6. The composition of claim 1, wherein the polyvinylpyrrolidone and the thermoplastic polymer is present in the polishing composition in a weight ratio of 1:10 to 100:1 respectively.

7. A polishing composition suitable for polishing semiconductor substrates having a nonferrous interconnect comprising:
0.1 to 1.5 wt % of polyvinyl alcohol having a weight average molecular weight of 13,000 to 23,000 g/mole;
0.01 to 0.85 wt % of polyvinylpyrrolidone having a weight average molecular weight of 3,000 to 10,000 g/mole;
up to 10 wt % of a corrosion inhibitor;
up to 15 wt % complexing agent;
up to 10 wt % of an oxidizing agent; and
0.1 to 40 wt % of a silica abrasive; wherein the polishing composition has a pH of at least 7, and further wherein varying the weight ratio of the thermoplastic polymer to the polyvinylpyrrolidone controls the removal rate of the non-ferrous interconnect.

8. A method of polishing a semiconductor substrate having a non-ferrous interconnect comprising the steps of:
applying a polishing composition comprising 0.1 to 1.5 wt % of a thermoplastic polymer; and 0.01 to 0.85 wt % of polyvinylpyrrolidone to a semiconductor substrate; and
polishing the semiconductor substrate at a pad pressure less than or equal to 21.7 kiloPascals, wherein varying the weight ratio of the thermoplastic polymer to the polyvinylpyrrolidone controls the removal rate of the non-ferrous interconnect.

9. The method of claim 8, wherein the polishing composition facilitates a removal rate of less than or equal to 150 Angstroms/minute for the low-k dielectric layer.

10. The method of claim 8, wherein the polishing composition facilitates a removal rate of greater than or equal to 150 Angstroms/minute for the low-k dielectric layer.
